(19) United States
(12) Patent Application Publication
(10) Pub. No.: US 2013/0166502 A1
(43) Pub. Date: Jun. 27, 2013

(54) SEGMENTED STORAGE FOR DATABASE CLUSTERING

(71) Applicant: Stephen Gregory WALKAUSKAS, Boston, MA (US)

(72) Inventor: Stephen Gregory WALKAUSKAS, Boston, MA (US)

(21) Appl. No.: 13/336,170

(22) Filed: Dec. 23, 2011

(51) Int. Cl. G06F 7/00

(52) U.S. Cl. 707/610; 707/E17.032; 707/E17.002

(57) ABSTRACT

This document describes, in various implementations, segmenting data of a database cluster into a plurality of segments, the data including a plurality of tuples, each segment including at least one of the tuples, and distributing the plurality of segments among nodes of the database cluster. Rebalancing of the data of the database cluster may be achieved by copying at least one of the plurality of segments from a source node of the database cluster to a destination node of the database cluster.

### BACKGROUND

Massively parallel processing (MPP) databases scale nearly linearly with the number of machines (often referred to as nodes) in a cluster of intercommunicating machines. For this reason MPP databases are widely used to analyze enormous amounts of data.

A database organizes and stores data in a format that is efficient for processing. Tuples or records of a relational database may, for example, be sorted or indexed, stored in row or columnar format, persisted to disk, or stored in a buffer in memory. The database may be organized or stored in a format that is efficient for a particular database architecture, which may include a combination of formats.

A number of machines or nodes that participate in an MPP database cluster may be a function of such criteria such as, for example, amount of data, number of users, type of users, or priority or importance of information. Any of these criteria may change over time. For example, the criteria may be correlated with a business cycle, such as end-of-month billing, or a seasonal event, such as holiday shopping.

In database clustering, storage of tuples or records of a relational database may be distributed, and redistributed, among the various nodes of the cluster.

### BRIEF DESCRIPTION OF THE DRAWINGS

FIG. 1 schematically shows a database cluster for application of an example of segmented storage for database clustering.

FIG. 2 schematically illustrates a node of the database cluster shown in FIG. 1.

FIG. 3 schematically illustrates an example of segmented storage of tuples of a database in a database cluster.

FIG. 4 schematically illustrates an example of rebalancing the database cluster shown in FIG. 3.

FIG. 5 is a flowchart depicting an example of a method for segmented storage for database clustering.

### DETAILED DESCRIPTION

In accordance with an example of segmented storage for database clustering, a database includes data that is arranged in the form of a plurality of tuples or records. Each tuple includes a set of related data fields. Such fields may be described by structural metadata. A plurality of tuples of the database may include the same fields. A field may contain a null value that is appropriate to a format of the field. Furthermore, a field might be multi-valued or otherwise general or flexible in nature.

In database clustering, multiple nodes cooperate to store and access tuples of the database. Each node may, for example, include a processing capability and an associated data storage capability. For example, a node may represent a computer of a computer cluster. In a computer cluster, a plurality of computers are linked or interconnected (e.g. via a network) and their operations are coordinated.

In other examples, a node may represent a group of one or more cores of a multi-core computer. Cores may be grouped together based on memory access characteristics. As an example, in a non-uniform memory access (NUMA) design, cores on the same socket or memory controller have relatively uniform memory access (and are good candidates to be grouped together into a logical node), whereas cores on different sockets have non-uniform memory access. Such arrangements of multiple cores or processors are herein also referred to as clusters.

In accordance with an example of segmented storage for database clustering, the tuples of the database and associated structures for facilitating access to the tuples (e.g. indexes) may be distributed among the nodes of the cluster. The tuples of the database and associated structures may be divided or segmented into a plurality of segments. The data in each segment may be compressed. Thus each segment may include a plurality of the tuples in compressed form. The segments may be distributed among the nodes, with some of the segments being stored on each of the nodes. For example, the segments may be distributed among the nodes such that the number of tuples stored on each node is approximately equal, or with a distribution that is related to a data storage capacity of each node.

For example, tuples may be segmented among the segments in an arbitrary (e.g. random or round-robin) order. In another example, tuples may be segmented deterministically, as described below.

An index or function may be included in a global catalog of the database which can be used to map each tuple to a particular segment. Only a subset of the tuple, the segmentation key, may be needed to map the tuple to the particular segment. For example, the global catalog, given values corresponding to a segmentation key, may indicate which segment includes tuples that match the given key. The global catalog may also point to a node where the segment, and thus the tuple, is stored. The global catalog may be accessible by each of the nodes. In this manner, when a tuple is to be retrieved, only the segment that contains that tuple need be decompressed.

Thus, tuples may be deterministically segmented in accordance with common content of the tuples as defined by segmentation key. For example, an appropriate hashing function may be applied to one or more fields of each tuple in order to assign the tuple to a segment. Such content-based segmentation may facilitate access to tuples of the database, for example, limiting examination of the database to segments that contain content relevant to a query.

During operation of a database cluster, the distribution of tuples and indexes among nodes may be modified, or rebalanced. For example, nodes may be added to or removed from the database cluster. Rebalancing may also be indicated by other circumstances, e.g. a frequency of access to a tuple, or deletion (or change in size) of one or more segments.

In accordance with an example of segmented storage for database clustering, redistribution of the tuples among nodes may simply include moving a segment from one node to another. In this manner, the database cluster may be rebalanced without decompressing a segment, or without decoding, interpreting, or otherwise altering the form of the data and associated structures.

Such rebalancing by moving segments containing tuples and associated structures in compressed form may be advantageous. For example, copying or moving a segment from node to node may involve simple byte-to-byte copying of the segment from one node to another.

By storing and operating on data that is segmented, the number of operations required to redistribute data may be reduced. Similarly, the time required for rebalancing, may be reduced (e.g. from weeks or days in some traditional database cluster systems, to hours or minutes for an example of segmented storage for database clustering). Thus, resources may be freed to handle other tasks. In this manner, efficiency of operation of the database cluster, or a system including the database cluster, may be improved, and adaptation to unforeseen changes facilitated.

On the other hand, in the absence of such segmented storage, as in some traditional database cluster systems, rebalancing of the database could include decompressing the data in the database, redistributing the tuples of the database among the nodes, recompressing the data, and rebuilding the associated structures (such as indexes). Thus, use of system resources could be relatively high, and memory or data storage space could be required to accommodate redundant, transitional data. For example, a tuple that is not to be transferred could be stored twice on a source node until the re-balance task completes.

On the other hand, in accordance with an example of segmented storage for database clustering, no decompressing of the data segments is necessary when moving a segment from node to node.

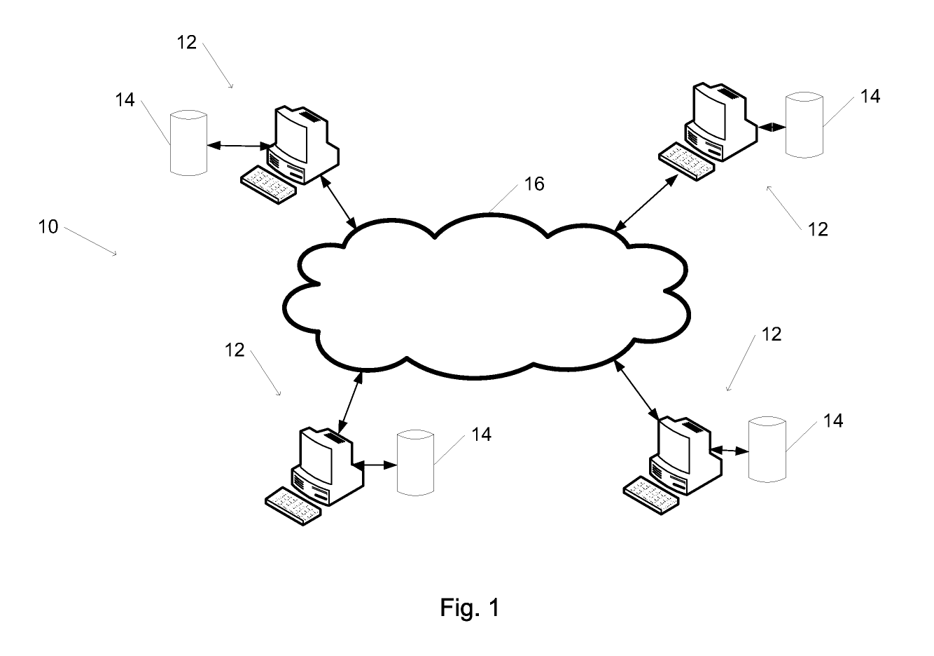

FIG. 1 schematically shows a database cluster for application of an example of segmented storage for database clustering.

Database cluster 10 includes a plurality of nodes 12. For example, each node 12 may represent a computer or a core of a multi-core processor unit. Each node 12 is associated with a data storage device 14. For example, each data storage device 14 may represent a data storage device of a computer or a memory location in a NUMA design.

For example, a data storage device 14 may be utilized to store a segment of a database for database cluster 10, a global catalog of the database, or a segmentation key for determining segmentation of the database.

Nodes 12 may communicate with one another via network 16. For example, network 16 may represent a connection among nodes 12, or a wired or wireless network.

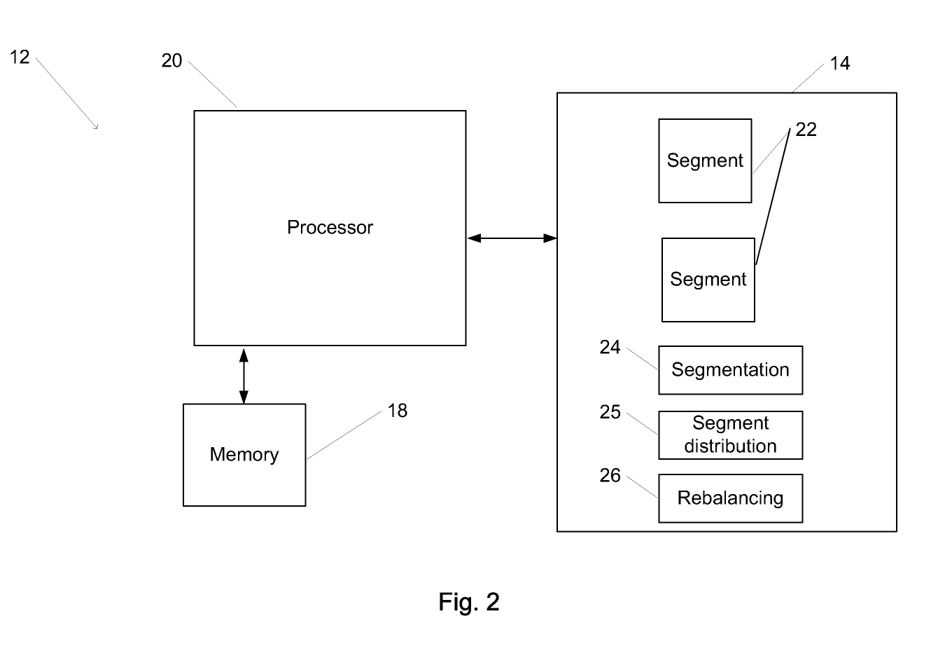

FIG. 2 schematically illustrates a node of the database cluster shown in FIG. 1. Node 12 includes a processor 20. For example, processor 20 may include one or more processors of a computer or other device, or one or more cores of a multi-core processor unit. Processor 20 may be configured to operate in accordance with programmed instructions. For example, processor 20 may be configured to perform operations with a database. For example, processor 20 may be configured to, in accordance with programmed instructions, segment a database, compress or decompress a portion of a database, add to or delete from a database, or locate a record or tuple of a database.

Processor 20 may communicate with memory 18. For example, memory 18 may represent a volatile or nonvolatile memory device or component. Memory 18 may be accessed by processor 20 or otherwise utilized to store, for example, programmed instructions for operation of processor 20, an index to a database, tuples of the database, a segmentation key, parameters for utilization during operation of processor 20, data generated by operation of processor 20, or other data.

Processor 20 may communicate with data storage device 14. For example, data storage device 14 may include one or more fixed or removable nonvolatile data storage devices. Data storage device 14 may be utilized to store, for example, programmed instructions for operation of processor 20, an index to the database, segments of the database, tuples of the database, a segmentation key, parameters for utilization during operation of processor 20, data generated by operation of processor 20, or other data. For example, data storage device 14 may be utilized to store one or more database segments 22.

For example, data storage device 14 may include a computer readable medium for storing programmed instructions for operation of processor 20. Such programmed instructions may include segmentation module 24 for segmenting tuples into segments, segment distribution module 25 for distributing segments among nodes, and rebalancing module 26 for performing rebalancing of the database. Data storage device 14 may represent a device that is remote from processor 20. For example, data storage device 14 may represent a storage device of a remote server. Such a remote server may store segmentation module 24, segment distribution module 25, or rebalancing module 26 in the form of an installation package or packages that can be downloaded and installed for execution by processor 20.

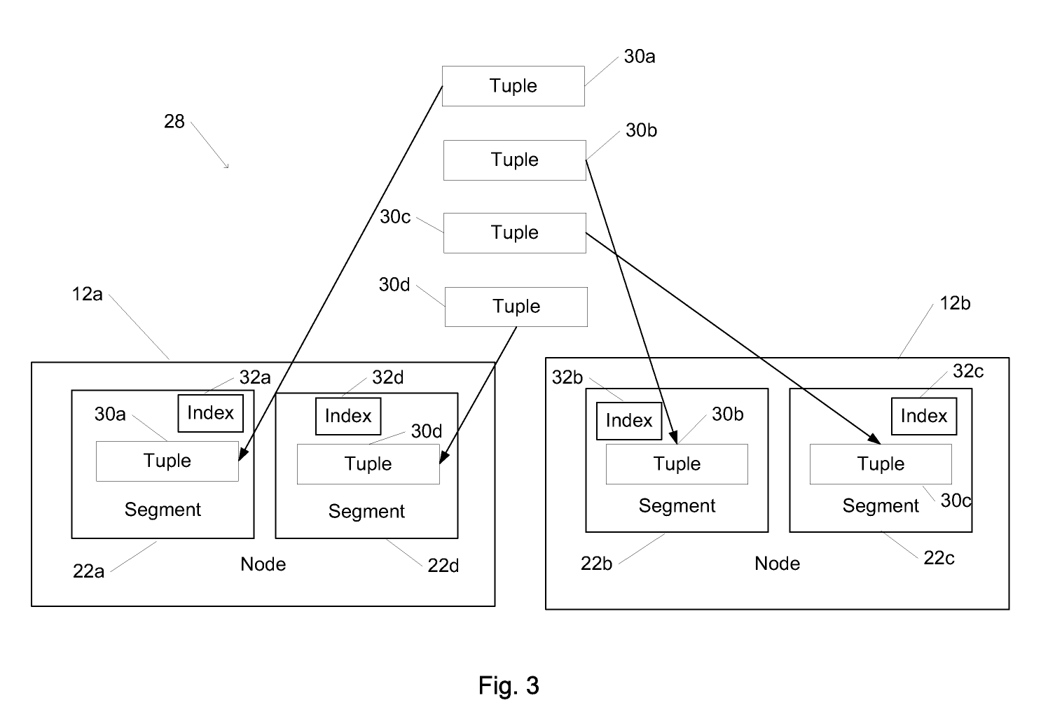

FIG. 3 schematically illustrates an example of segmented storage of a database in a database cluster. For simplicity, only four tuples, four segments, and two nodes of the illustrated database are shown. The shown tuples, segments, and nodes may be understood as being representative of a larger number of tuples, segments, and nodes that are not shown.

Database cluster 28 includes tuples 30a through 30d, and, initially, nodes 12a and 12b. Tuples 30a through 30d may be distributed among segments 22a through 22d. For example, each tuple 30a through 30d may be distributed randomly or arbitrarily among segments 22a through 22d. A structure associated with the tuples included in each segment 22a through 22d, such as indexes 32a through 32d, may also be included in that segment.

As another example, a segmentation key may be applied, e.g. by a hashing function, to assign each tuple 30a through 30d to one of segments 22a through 22d. For example, each segment 22a through 22d may be characterized by a content of a field of tuples 30a through 30d.

In such a manner, operations on tuples of each segment may be optimized. For example, a join operation or query operation may be expedited by limiting the operation to relevant segments, as indicated by the segmentation key.

For example, each of tuples 30a through 30d may be assigned to each of segments 22a through 22b, respectively.

Each segment 22a through 22d may be stored on one of nodes 12a or 12b. For example, segments 22a through 22d may be configured to be similar in size (e.g. all of segments 22a through 22d including similar numbers of tuples, such as tuples 30a through 30d). Similarly, segments may be distributed substantially uniformly among nodes, such as nodes 12a and 12b. Thus, in the example shown, segments 22a and 22d are stored on node 12a, and segments 22b and 22c are stored on node 12b.

In another example, segments, such as segments 22a through 22d, may be stored in a manner that is related (e.g. proportional) to a storage capacity of, or speed of access to, each node. Thus, more segments may be stored on a node that has more storage capacity, or may be accessed more quickly, than on a node with less storage capacity or with slower access. Segments may be distributed arbitrarily (e.g. in random or round-robin fashion) among nodes. As another example, a segment may be assigned to a node based on content of the segment. For example, a hash function that is related to a segmentation key may be applied to each segment (e.g. based on a common content of tuples that were included in that segment). Thus, a segment whose tuples include content that is similar or related to content of tuples of another segment may be stored on the same node as that other segment.

The storage of segments on various nodes may be redistributed, thus rebalancing the tuples of the database cluster, e.g. in response to a change. Such a change may include, for example, a change in the number of available nodes of the database cluster, or a change in the contents of one or more of the segments.

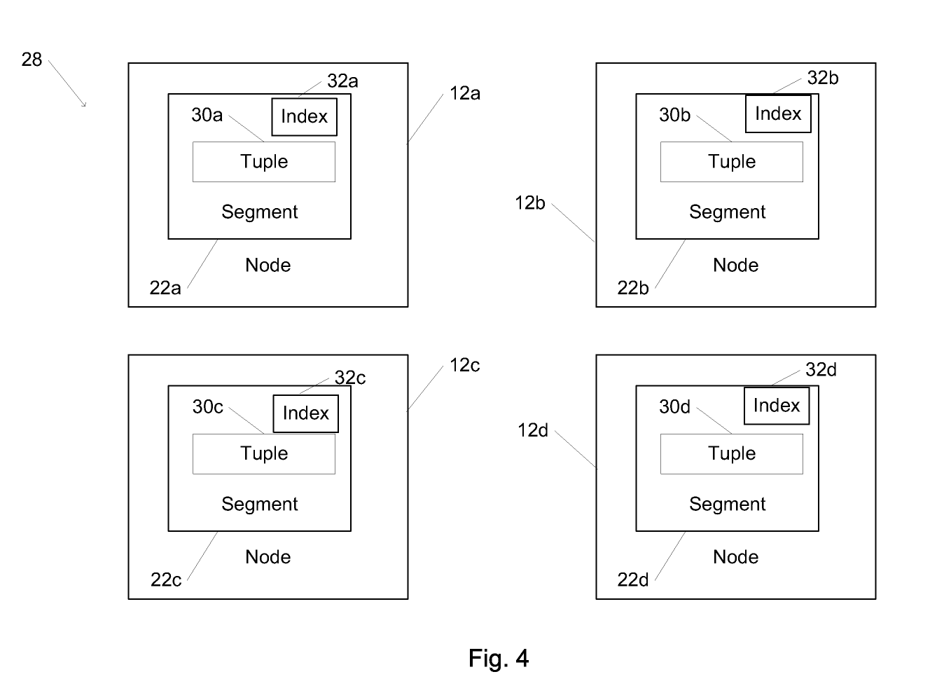

FIG. 4 schematically illustrates an example of rebalancing the database cluster shown in FIG. 3. As shown in FIG. 4, two additional nodes, node 12c and node 12d, have been added to database cluster 28. Thus, rebalancing of database cluster 28 may involve redistributing segments 22a through 22d among all of nodes 12a through 12d.

In order to achieve rebalancing of database cluster data 28, e.g. so as to evenly distribute segments 22a through 22d among nodes 12a through 12d, two of segments 22a through 22d are copied to added nodes 12c and 12d.

In the example shown in FIG. 4, segment 22d has been moved from node 12a (as shown in FIG. 3, prior to rebalancing) to added node 12d. Similarly, segment 22c has been moved from node 12b to added node 12c. For example, selection of segments 22c and 22d for moving during rebalancing may have been arbitrary (e.g. random), or based on one or more criteria (e.g. related to a content of tuple 30a through 30d in each of segments 22a through 22d).

For example, segment 22c (and similarly for segment 22d) may have been moved by a byte-to-byte operation. In such an operation, each byte of segment 22c is transferred from node 12b to node 12c (e.g. first copied from node 12b to node 12c and then deleted from node 12b). In this manner, moving segment 22c from node 12b to node 12c does not include decompressing segment 22c. No operations are performed on segment 22b that is not moved from node 12b (and, similarly, no operations are performed on segment 22a that is not being moved from node 12a).

In order to ensure proper functioning of the database concurrently with rebalancing, the database cluster may be configured to maintain ACID (atomicity, consistency, isolation, durability) properties. For example, when rebalancing, a segment may be copied from a first node to a second node. The segment may and only be deleted when the copying is verified to have been successful. Thus, any such transactions such as queries, data manipulation language (DML) operations, or data description language (DDL) operations may be referred to the copy of the segment on the first node until the rebalancing has been verified to be successful.

The number of segments in accordance with an example of segmented storage for database clustering may be a multiple of the number of nodes in the cluster, a power of two, or based on another exponent. Thus, when called for, a number of segments may be increased by dividing each segment into two. The division of the segment may remain local to a single node. Thus, no transfer of data over the network is necessary. After division, rebalancing of the database cluster may result in transferring one or more segments from node to node.

A segment may be replicated from a first node to one or more additional nodes. Such replication may provide a database cluster with tolerance to faults, e.g. if a node of the database cluster fails. Thus, if the first node fails, the data in the segment may remain accessible on one or more of the other nodes. In order to increase the probability of data surviving multiple node failures, rebalancing may place segments in such a way as to reduce the number of dependencies for each node (machine). Thus, the likelihood of multiple failures causing a loss of some of the data may be reduced.

For example, consider database cluster 28 as shown in FIG. 3. If a segment 22a is replicated just once (e.g. as segment 22b) and the replica and original are placed on different nodes (e.g. machines) of database cluster 28 (e.g. nodes 12a and 12b), a dependency is created between those nodes. If neither node 12a nor node 12b is accessible, the segment (both original and replica) is inaccessible. However, an arbitrary number of nodes other than nodes 12a and 12b may be inaccessible without affecting access to segment 22a or its replica. Another segment on node 12a, such as segment 22d, may also be replicated just once (e.g. as segment 22c). In this case, storing the replica on node 12b avoids introducing another node dependency. This example can be extrapolated to an arbitrary number of replicas of each segment.

A processor associated with the database cluster, such as a processor associated with a node of the database cluster, may execute a method for segmented storage for database clustering.

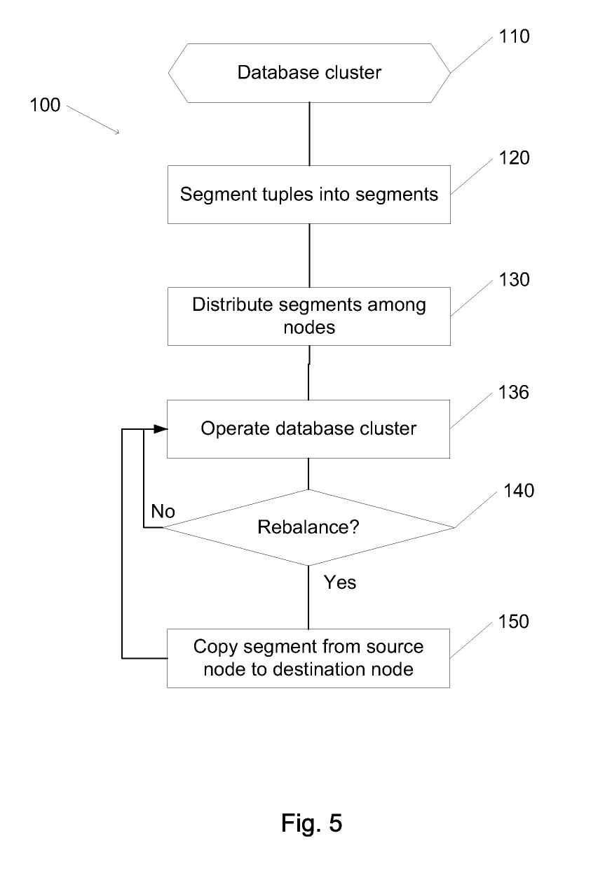

FIG. 5 is a flowchart depicting an example of a method for segmented storage for database clustering. It should be understood that the illustrated division of the depicted method into discrete operations that are represented by blocks of the flowchart has been selected for convenience and clarity only. Alternative division of the depicted method into operations represented by blocks is possible, with equivalent results. Such alternative division into discrete operations should be understood as representing another example of the depicted method.

It should also be understood that, unless indicated otherwise, the illustrated order of operations that are represented by blocks of the flowchart has been selected for convenience and clarity only. Operations of the depicted method may be executed in a different order, or concurrently, with equivalent results. Such alternative ordering of operations represented by blocks should be understood as representing another example of the depicted method.

Database cluster segmented storage method 100 may be performed by a processor of a database cluster, such as a processor of a node.

Database cluster segmented storage method 100 may be performed on a database cluster (block 110). The database cluster may include tuples of the database, each tuple including one or more related fields, and associated structures, such as indexes. The database cluster may include a plurality of intercommunicating nodes. For example, the nodes may intercommunicate via a network.

The tuples of the database are segmented into a plurality of segments (block 120). For example, the tuples may be segmented into segments arbitrarily (e.g. round-robin or random distribution), or deterministically in accordance with a segmentation key (e.g. applied via a hash function). A segmentation key may be based on a content of one or more fields of the tuples. For example, a segmentation key may indicate segmentation into a single segment of all tuples that include a common content of one or more of the fields (e.g. a common business entity, geographic location, or similar field content).

Each segment may also include one or more structures that may enable or expedite processing of the tuples. For example, such a structure may include an appropriate index to the included tuples.

Each segment may be compressed, encoded, or otherwise manipulated such that access to content of tuples of the segment requires additional operations (e.g. decompressing or decoding).

The segments are distributed among nodes of the database cluster (block 130). For example, the segments may be distributed such that each node of the database cluster stores an approximately equal number of segments. A global catalog of the segments may be available to all nodes of the database cluster. Accessing the global catalog may provide information as to a location of each of the segments, and of each tuple of the database.

Distribution of the segments among nodes may be selected to provide fault tolerance or to otherwise enhance efficiency of operation of the database cluster.

The database cluster may operate on the segmented and distributed database (block 136). For example, operation of the database cluster may include adding, deleting, or modifying (e.g. editing) tuples (or records), and querying the database. During operation, one or more tuples of the database may be accessed. For example, in order to access a tuple of the database, the segment that includes the tuple to be accessed may be decompressed or otherwise modified or processed.

During operation of the database cluster, rebalancing may be desired or indicated (block 140). Rebalancing may be indicated when a distribution of segments among the available nodes becomes skewed, with at least one of the nodes storing more or fewer segments than others. For example, a distribution may be considered to be skewed if a distribution of segments among the nodes deviates, as determined by predetermined criteria, from a preferred distribution (e.g. an even distribution or a distribution in proportion to node storage capacity).

Rebalancing may be indicated when the number of nodes that are available to the database cluster increases (thus adding a node to which no segments had been distributed) or decreased (e.g. by anticipated removal of a node, thus requiring redistributing segments from the node that is to be removed to other nodes of the database cluster). If a node is unexpectedly removed (e.g. due to failure), rebalancing may include replicating copies of the segments that were on the unexpectedly removed node so as to ensure a desired failure tolerance.

The database cluster may continue to operate (returning to block 136), e.g. when no rebalancing is indicated or concurrent with rebalancing.

When rebalancing is indicated, one or more segments may be copied from a source node (where the segment had been stored prior to rebalancing) to a destination node (block 150). The segment may be copied without accessing or altering contents of the segment. For example, the segment is not decompressed, decoded, or otherwise altered or modified. Duplicate copies of the copied segment may be maintained, or the segment may be deleted from the source node upon verification of successful copying to the destination node. The database cluster may continue to operate (returning to block 136).

In accordance with an example of segmented storage for database clustering, a computer program application stored in non-volatile memory or computer-readable medium (e.g., register memory, processor cache, RAM, ROM, hard drive, flash memory, CD ROM, magnetic media, etc.) may include code or executable instructions that when executed may instruct or cause a controller or processor to perform methods discussed herein, such as an example of a method for segmented storage for database clustering.

The computer-readable medium may be a non-transitory computer-readable media including all forms and types of memory and all computer-readable media except for a transitory, propagating signal. In one implementation, external memory may be the non-volatile memory or computer-readable medium.

We claim:

1. A method comprising:
segmenting data of a database cluster into a plurality of segments, the data including a plurality of tuples, each segment including at least one of the plurality of tuples; and
distributing the plurality of segments among nodes of the database cluster such that rebalancing of the data of the database cluster comprises copying at least one of the plurality of segments from a source node of the database cluster to a destination node of the database cluster.

2. The method of claim 1, wherein segmenting the data comprises including in the segment a structure to expedite access to at least one of the plurality of tuples.

3. The method of claim 1, wherein content of the plurality of segments is compressed.

4. The method of claim 3, wherein copying at least one of the plurality of segments comprises copying said at least one of the plurality of segments in compressed form.

5. The method of claim 1, wherein segmenting the data comprises applying a segmentation key to the plurality of tuples.

6. The method of claim 1, wherein segmenting the data comprises applying a round-robin distribution to the plurality of tuples.

7. The method of claim 1, further comprising rebalancing of the data of the database cluster when a distribution of segments among nodes becomes skewed.

8. The method of claim 1, further comprising rebalancing of the data of the database cluster when a node is added to or is to be removed from the database cluster.

9. A non-transitory computer readable medium having stored thereon instructions that, when executed by a processor, cause the processor to:
segment data of a database cluster into a plurality of segments, the data including a plurality of tuples, each segment including at least one of the plurality of tuples, content of the plurality of segments being compressed; and
distribute the plurality of segments among nodes of the database cluster, such that rebalancing of the data of the database cluster comprises copying at least one of the plurality of segments from a source node of the database cluster to a destination node of the database cluster.

10. The non-transitory computer readable medium of claim 9, wherein segmenting the data comprises including in the segment a structure to expedite access to at least one of the plurality of tuples.

11. The non-transitory computer readable medium of claim 9, wherein segmenting the data comprises applying a segmentation key to the plurality of tuples.

12. The non-transitory computer readable medium of claim 9, wherein segmenting the data comprises applying a round-robin distribution or random distribution to the plurality of tuples.

13. The non-transitory computer readable medium of claim 9, further comprising instructions that cause the processor to rebalance the data of the database cluster when a distribution of segments among nodes becomes skewed.

14. The non-transitory computer readable medium of claim 9, further comprising instructions that cause the processor to rebalance the data of the database cluster when a node is added to or is to be removed from the database cluster.

15. A system comprising a plurality of interconnected nodes, a node of the plurality of interconnected nodes including a processing unit in communication with a computer readable medium, wherein the computer readable medium contains a set of instructions that, when executed, cause the processing unit to:
segment data of a database cluster into a plurality of segments, the data including a plurality of tuples, each segment including at least one of the plurality of tuples;
distribute the plurality of segments among nodes of the database cluster; and
rebalance the data of the database cluster by copying at least one of the plurality of segments from a source node of the database cluster to a destination node of the database cluster.

16. The system of claim 15, wherein the set of instructions further cause the processing unit to include in a segment of the plurality of segments a structure to expedite access to at least one of the tuples.

17. The system of claim 15, wherein the set of instructions further cause the processing unit to compress content of the plurality of segments.

18. The system of claim 15, wherein the set of instructions further cause the processing unit to apply a segmentation key to the plurality of tuples to segment the data.

19. The system of claim 15, wherein the set of instructions further cause the processing unit to apply a round-robin or random distribution to the plurality of tuples to segment the data.

20. The system of claim 15, wherein the set of instructions further cause the processing unit to rebalance the data of the database cluster when a distribution of segments among nodes becomes skewed, or when a node is added to or deleted from the database cluster.
